(19) United States
(12) Patent Application Publication
(10) Pub. No.: US 2009/0218918 A1
(43) Pub. Date: Sep. 3, 2009

(54) Mirrored Media Cabinet

(76) Inventors: Ed Wilson, Sharpsburg, GA (US); Ron Thames, Geneva, AL (US)

Correspondence Address: STEVEN L. SCHMID, 1824 HICKORY TRACE DRIVE, FLEMING ISLAND, FL, 32003, US

(21) Appl. No.: 12/235,271

(22) Filed: Sep. 22, 2008

Related U.S. Application Data
(60) Provisional application No. 61/033,112, filed on Mar. 3, 2008.

(51) Int. Cl. A47B 81/06; A47B 81/00; F16M 11/00

(52) U.S. Cl. 312/7.2; 312/224; 248/176.1

(57) ABSTRACT

Disclosed is a media cabinet including mirrors for revealing a media display. The mirrored media cabinet allows a dresser to function as a television stand and dresser combination which would normally require two separate cabinets. The media cabinet eliminates the need for an additional chest or armoire for television storage, which can save space while concealing the television when not in use.

### RELATED APPLICATION

This application relies upon U.S. Provisional Patent Application, U.S. Ser. No. 61/033,112 filed Mar. 3, 2008 wherein the content of the relied upon provisional application is incorporated herein in its entirety.

### TECHNICAL FIELD

The present invention relates to an article of furniture for media components and in particular the invention relates to a mirrored media cabinet capable of being placed on an article of furniture and capable of, but not limited to housing a flat panel display.

### BACKGROUND

The current state of the art in media centers for housing a display typically includes a cabinet of sufficient depth as to house a CRT screen display. Such a cabinet is usually a dedicated piece of furniture comprised of drawers or cabinets at the bottom and a pair of doors which swing open to revile the display. The known media cabinets are bulky, single function units that are designed to essentially house only CRT displays.

Furthermore, as technology has advanced, more and more television sets are being manufactured that are substantially thinner than prior television sets. Such thin screen technology includes plasma and LCD screen televisions. As these technologies have become more prevalent, the need for furniture specifically adapted to support these thin screen media has grown. Existing furniture has generally been ill suited to support these thin screen media.

Thus, what is needed is a media cabinet that can serve various functions instead of existing as a dedicated large furniture object. Furthermore, it would be preferable to have an article of furniture capable of housing a flat panel display, including those of a substantial width. Thus, what is needed is a multifunctional media cabinet capable of accommodating various media displays.

### SUMMARY

The present invention comprises a media cabinet including mirrors for revealing a media display. The mirrored media cabinet allows a dresser to function as a television stand and dresser combination which would normally require two separate cabinets. The media cabinet eliminates the need for an additional chest or armoire for television storage, which can save space while concealing the television when not in use.

The mirrored doors which reveal the media display may slide to reveal the display or swing open to reveal the display. The mirrored doors may be manually operated or they may be electronically operated. In the electronically operated embodiment, it is contemplated the doors may be operated via a remote control. The mirrored doors can serve the function of providing a mirror while also hiding the media display. Furthermore, mirror doors are typically a less expensive option than wooden doors.

The mirrored media cabinet may be formed in two part modules, wherein one part houses the media display behind the mirrored doors. This part may be placed on any piece of furniture a person would desire to serve as a media center. For example, the first part module may be place on a dresser found in any bedroom to create a media cabinet. Furthermore, the mirror media cabinet may be sold as a two part modular set wherein the second part module comprises a dresser.

The first part module may be sized as to fit any size media display. Furthermore, the first part module may be of varying depths as to accommodate the thin profile of a plasma or LCD television set. A thin profile of the first part lends itself to create the simple illusion of a dresser and mirror combination. This look eliminates the often undesirable appearance of a large dedicated media cabinet.

The present invention is not limited to any one type of furniture source and may include others using a sliding door/mirror with a dresser concept.

### DRAWINGS

In the drawings:

FIG. 1 illustrates the mirrored media cabinet of the present invention comprising the first part module and the second part module embodied as a dresser;

FIG. 2 depicts the first part module having sliding mirrored doors;

FIG. 3 is a further depiction of the first part module having mirrored doors; and

FIG. 4 illustrates the second part module embodied as a dresser.

### DETAILED DESCRIPTION

Disclosed is a media cabinet including mirrors for revealing a media display. The term cabinet is used only in the present application to refer to an article of furniture, which may have various embodiments. The mirrored media cabinet allows a dresser to function as a television stand and dresser combination which would normally require two separate cabinets. The mirrored media cabinet eliminates the need for an additional chest or armoire for television storage, which can save space while concealing the television when not in use.

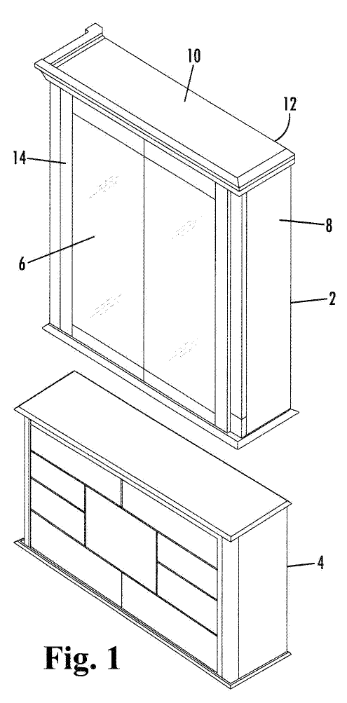

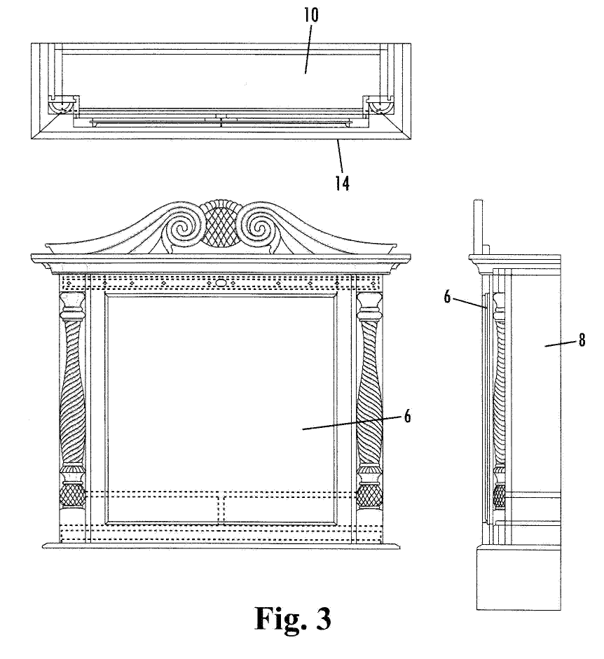

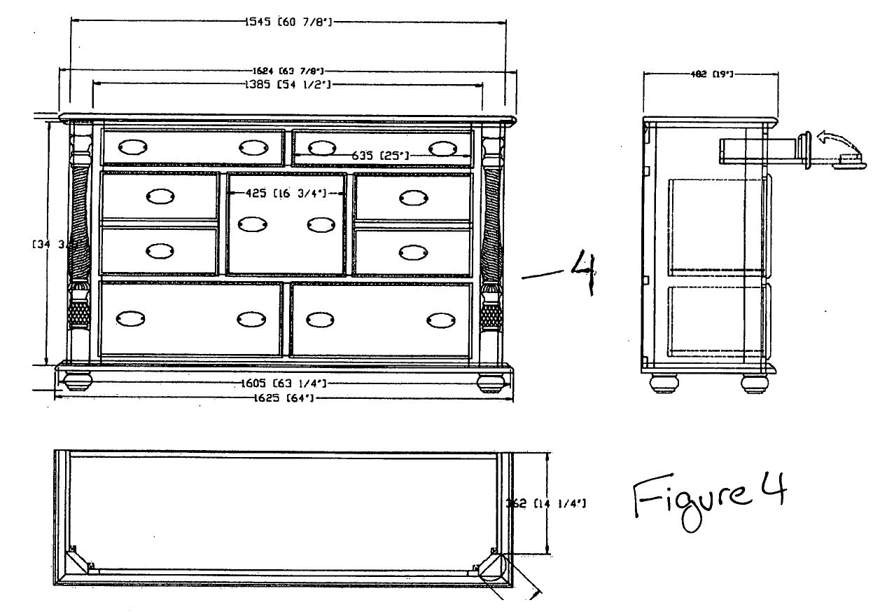

Referring now in greater detail to the drawings in which like numerals indicate like items throughout the several views, FIGS. 1-4 depict the present mirrored media cabinet in various embodiments of the present invention.

Illustrated in FIG. 1 is the media cabinet, including an open faced housing 2 having an opening 14 and back panel 12 opposed to the opening 14. The media cabinet further includes opposed side panels 8 and a top panel 10 forming a compartment within sized to fit a media element such as a television.

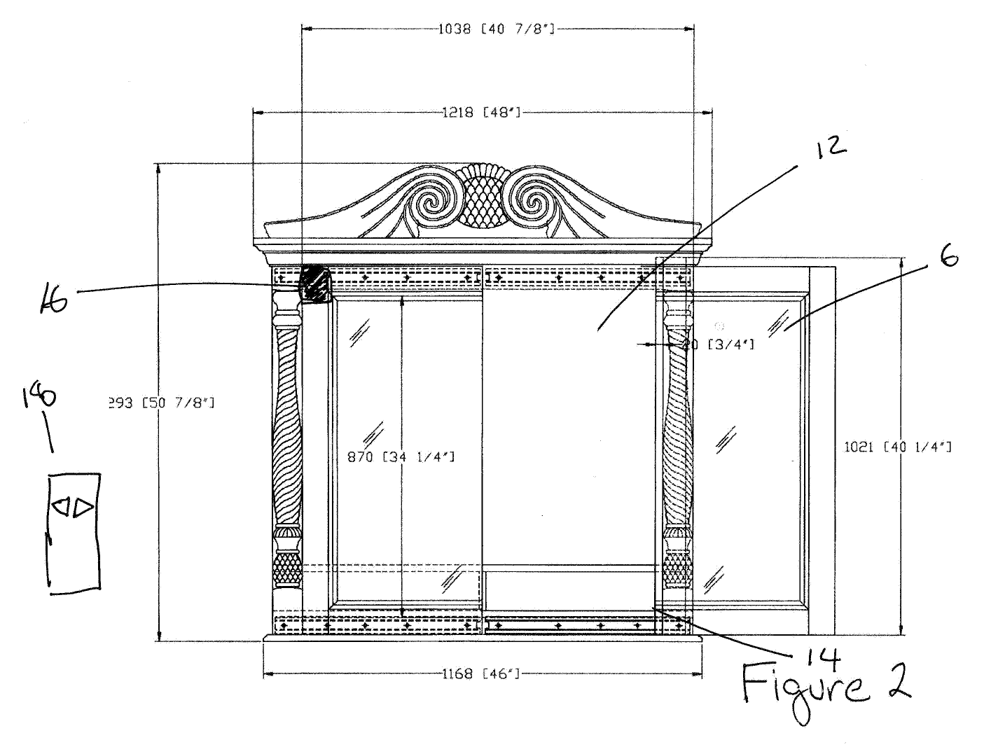

Further depicted in FIG. 1, is a mirrored panel 6 fitted within the opening 14 of the housing 2 whereby a visual media element can be positioned with the housing 2 and revealed by moving the mirrored panels 6 fitted within the opening 14. The mirrored panel 6 may be moved by being hinged to the opposed side panels 8 whereby the mirrored panel can be swung open. In a further embodiment the mirrored panel 6 slidably affixed to the media cabinet whereby the mirrored panel can be slid open to reveal the media element within the cabinet as shown in FIG. 2.

Additional embodiments include the media cabinet including at least two mirrored panel elements 6 fitted within the opening 14 of the housing 2. The number of mirrored panels 6 is only limited by practicality of assembly. For instance typically two mirrored panels 6 are used in the cabinet since opening two panels 6 is easier for one to open and take up a smaller footprint when open. However, one panel 6 may be used or more than two panels in the various embodiments of the present invention.

As illustrated in FIGS. 1-4 the present media cabinet may include a first module 2 and a second module 4 wherein the second module 4 includes a stand for the first module 2. The first module 2 may rest upon the second module 4 and may be attached to the first module 2 using such attachment means as screws. Additionally, the media cabinet may simply be comprised of the first module 2 which may rest on any piece of furniture or rest upon the floor. The second module 4 may be a dresser unit.

The media cabinet may be sized to house a media element selected from the group of flat panel displays consisting of an LCD television and a plasma television. However the cabinet may be sized in a further embodiment to fit a CRT unit. The cabinet may be sized to fit further audio visual units desire by a user.

A further embodiment as illustrated in FIG. 2 includes the mirrored panel 6operatively connected to a motor 16 for opening and closing the mirrored panel 6. The motor 16 may be actuated via a remote control device 18.

While Applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A media cabinet comprising;
an open faced housing including an opening, a back panel opposed to the opening, opposed side panels and a top panel forming a compartment within; and
a mirrored panel fitted within the opening of the housing whereby a visual media element can be positioned with the housing and revealed by moving the mirrored panels fitted within the opening.

2. The media cabinet of claim 1, further including the mirrored panel hinged to the opposed side panels whereby the mirrored panel can be swung open.

3. The media cabinet of claim 1, further including a mirrored panel slidably affixed to the media cabinet whereby the mirrored panel can be slid open to reveal the media element within the cabinet.

4. The media cabinet of claim 1, further including at least two mirrored panel elements fitted within the opening of the housing.

5. The media cabinet of claim 1, wherein the media cabinet further includes a stand wherein the housing having the mirrored panel rests upon.

6. The media cabinet of claim 5, wherein the stand includes a dresser.

7. The media cabinet of claim 1, wherein the open faced housing sized to house a media element selected from the group consisting of an LCD television and a plasma television.

8. The media cabinet of claim 1, further including the mirrored panel operatively connected to a motor for opening and closing the mirrored panel.

9. The media cabinet of claim 8, wherein the motor is actuated via a remote control device.

10. A media cabinet comprising;
a first module including an open faced housing including an opening, a back panel opposed to the opening, opposed side panels and a top panel forming a compartment within;
a mirrored panel fitted within the opening of the housing whereby a visual media element can be positioned with the housing and revealed by moving the mirrored panels fitted within the opening; and
a second module comprising a stand whereby the first module can reside upon the second module.

11. The media cabinet of claim 10, wherein the second module is a dresser.

12. The media cabinet of claim 10, further including the mirrored panel hinged to the opposed side panels whereby the mirrored panel can be swung open.

13. The media cabinet of claim 10, further including a mirrored panel slidably affixed to the media cabinet whereby the mirrored panel can be slid open to reveal the media element within the cabinet.

14. The media cabinet of claim 10, further including at least two mirrored panel elements fitted within the opening of the housing.

15. The media cabinet of claim 10, wherein the open faced housing sized to house a media element selected from the group consisting of an LCD television and a plasma television.

16. The media cabinet of claim 10, further including the mirrored panel operatively connected to a motor for opening and closing the mirrored panel.

17. The media cabinet of claim 16, wherein the motor is actuated via a remote control device.

18. A media cabinet comprising;
a first module including an open faced housing including an opening, a back panel opposed to the opening, opposed side panels and a top panel forming a compartment within;
a plurality mirrored panels fitted within the opening of the housing whereby a visual media element can be positioned with the housing and revealed by moving the mirrored panels fitted within the opening, and the mirrored panels operatively connected to a motor for opening and closing the panels, and the motor is actuated via a remote control device; and
a second module comprising a dresser whereby the first module can reside upon the second module.

19. The media cabinet of claim 18, further including the mirrored panels hinged to the opposed side panels whereby the mirrored panel can be swung open.

20. The media cabinet of claim 18, further including a mirrored panels slidably affixed to the media cabinet whereby the mirrored panel can be slid open to reveal the media element within the cabinet.
